(19) United States
(12) Patent Application Publication
(10) Pub. No.: US 2005/0167881 A1
(43) Pub. Date: Aug. 4, 2005

(54) Inline spiral extrusion head

(76) Inventors: Prem Anand, Roswell, GA (US); Jasmin Sehovic, Clearwater, FL (US)

Correspondence Address: Ronald J. Kisicki, Esq.;JAECKLE FLEISCHMANN & MUGEL, LLP, Suite 200, 39 State Street, Rochester, NY, 14614-1310, US

(21) Appl. No.: 10/770,300

(22) Filed: Feb. 2, 2004

(51) Int. Cl. B29C 47/20

(52) U.S. Cl. 264/209.8; 425/380

(57) ABSTRACT

A polymer extrusion head for forming extruded elements includes a tapered supply section and a one-piece helicoid manifold comprising an entrance cone, a spider element for splitting the flow into multiple streams, a cylindrical transition and flow-turning zone, a flow space for re-mixing the streams, and a conical zone. A conical choke ring surrounds the conical zone. An extrusion tip and die are disposed downstream of the manifold and body. The body and die are provided with heaters, and the manifold and extrusion tip may include internal heaters. The extrusion tip may be accessed for maintenance or changeover to another shape or size. The die surrounding the tip may be readily centered with respect to the tip. An axial surface in the die acts as a seat for the choke ring.

### TECHNICAL FIELD

The present invention relates to apparatus for extrusion forming of molten polymer material; more particularly, to inline extrusion heads for continuous extruding of hollow or solid shapes; and most particularly, to an inline spiral extrusion head wherein the flow of material is cleanly divided by multi-funnel shaped spider into a plurality of annularly arranged streams which then are spirally recombined to eliminate longitudinal knit lines.

### BACKGROUND OF THE INVENTION

Extrusion heads for continuous extrusion forming of continuous plastic elements having specific cross-sectional shapes are well known. Such extruded elements may include, for example, pipes, rods, moldings, tubings, and the like.

In a typical prior art extrusion system, solid pellets of the thermoplastic material to be used are fed into a progressive-screw extruder wherein the pellets are liquefied under high pressure and are injected into an extrusion head. Typically, such injection is made axially of the extrusion head; hence, the term “inline” in the art, and as used herein, as opposed to “crosshead” wherein the molten extrudate enters the extrusion head at an angle, typically 90°, to the axis of the head.

Prior art extrusion heads typically are formed of a collection of individual sections, each section being responsible for a particular manipulation of the flowing stream. The single, axial stream first encounters a male conical section having the conic apex pointing upstream, such that the axial stream is converted into an annular stream.

Leaving the conical section, the annular stream is divided by a spider section into a plurality of individual laminar streams, the purpose of the spider being to provide mechanical integrity while providing an annular flow path.

Downstream of the spider section, the individual streams are recombined in a mandrel section into a single annular stream of improved thickness uniformity. The annular stream is then typically directed through a female frusto-conical section, known generally in the art as a choke ring or wedge ring, wherein the flow is accelerated, the annular stream thickness is reduced, and the outside diameter of the annular stream is reduced or increased. The choke ring can further smooth out non-uniformities in the annular extrudate.

The annular stream is then directed into a male and female die section wherein the stream is shaped into a desired cross-sectional form and extruded for cooling, setting, and further treatment as may be necessary.

Several problems are known to exist both in operation of a prior art extrusion head and in product extruded therefrom.

First, the conical section, spider section, and mandrel section are formed as individual units which are then joined together. The joints therebetween define small discontinuities in the flow surfaces which cause small areas of flow stagnation. Molten polymer in these areas can become degraded to form either unwelcome hard protrusions into the flow stream or slugs that break loose and create defects in the finished product.

Second, a prior art spider includes a plurality of radially-arranged fins, typically air-foil shaped, around which the extrudate flows and is divided and then recombined. As the extrudate enters and flows through the spider it undergoes compression as the total flow cross-section is progressively reduced. However, upon passing the broadest dimension of the fins, the extrudate undergoes decompression as the flow cross-section increases. Again, the lee of the fins is a known area of flow stagnation.

Third, downstream of the spider in the manifold section, the individual streams must recombine along a plurality of mutual joining surfaces, known in the art as knit lines or weld lines. The quality of such knitting is of great concern and can be compromised by stagnation at the spider fins. Further, in general the knit lines are visible in the final extruded product, which can be visually undesirable. Further, longitudinal knit lines are lines of minimum burst strength, which is a serious concern in extruded piping and is a cause for otherwise excessive wall thickness, which is a waste of material.

Fourth, the pressures to which the molten polymer is subjected within the apparatus can cause plastic leakage at joints in the extrusion head, especially at the transition from the choke collar to the die.

Fifth, the quality of the final extruded shape requires very accurate placement of the extrusion tip and extrusion die elements with respect to each other. Adjustment of either one in prior art extrusion heads is difficult and time-consuming.

Sixth, at start-up of a prior art extrusion head, and especially a relatively large head having a large thermal mass, the extrusion dies must be heated externally, typically via a blowtorch, to prevent the first extrudate entering the die from setting therein and causing the entire process to seize.

Seventh, the extrusion tip is an integral part of some prior art mandrels, or if removable, it requires extensive and time-consuming unthreading.

It is a principal object of the present invention to provide extruded polymer elements having a high degree of polymeric structural uniformity.

### SUMMARY OF THE INVENTION

Briefly described, an inline polymer extrusion head in accordance with the invention includes a first tapered supply section for receiving molten polymer from a supply means. An integral helicoid manifold downstream of the supply section includes an entrance cone, a non-stagnating spider element, a cylindrical transition and flow-turning zone, a helical progressive flow-mixing zone, and a conical zone. A conical choke ring concentrically surrounds the conical zone. The mandrel and choke ring are disposed within a generally cylindrical body. An extrusion tip and die are disposed downstream of the manifold and body. The body and flange are provided with resistance heaters. Optionally, the extrusion tip and the manifold include an internal resistance heater and the die external heater.

The helicoid manifold is formed as a single entity to eliminate joints in the polymer flowpath, as in the prior art. The entrance cone surface leads smoothly into the spider section, which comprises a plurality of annularly-arranged funnel-shaped passages that meet in knife edges at their upstream ends. Each funnel-shaped passage leads smoothly and without stagnation zones into a generally cylindrical passage leading in an axial direction into the transition and flow-turning section of the manifold. Here, the outer surface of the manifold is cylindrical and close-fitting to the surrounding body and is formed into a plurality of passages. These passages are smoothly turned from axial to become helical along the manifold surface, which becomes conical. Thus the passages become progressively shallower and the clearance between the manifold surface and the cylindrical body becomes progressively greater. As the passage depth becomes zero, the manifold surface becomes a smooth frusto-cone from which the conical choke ring is off-spaced.

The extrusion tip fits into a well in the end of the manifold and may be readily accessed for maintenance or changeover to another shape or size. The tip surface makes a smooth juncture with the manifold surface. The tip may be hollow and may be provided with an internal resistance heater for facilitating extrusion start-up.

The die surrounding the tip is fitted loosely into a well in the end of the body and is secured by a plurality of radial positioning screws in the body such that the die may be readily centered or otherwise positioned with respect to the extrusion tip. An internal axial surface in the die acts as a seat and seal for the choke ring which is urged against the seat by the force of polymer flowing through the head.

### BRIEF DESCRIPTION OF THE DRAWINGS

The present invention will now be described, by way of example, with reference to the accompanying drawings, in which:

FIG. 1 is an isometric view of a complete extrusion head assembly in accordance with the invention;

FIG. 2 is an axial vertical cross-sectional view of the extrusion head assembly shown in FIG. 1;

FIGS. 3a-3c are various isometric views of a helicoid manifold suitable for use in an extrusion head assembly, FIG. 3b being partially in cut-away;

FIG. 4 is a horizontal cut-away view of the assembly shown in FIG. 1; and

FIG. 5 is a quarter cut-away view of the assembly shown in FIG. 1.

### DESCRIPTION OF THE PREFERRED EMBODIMENTS

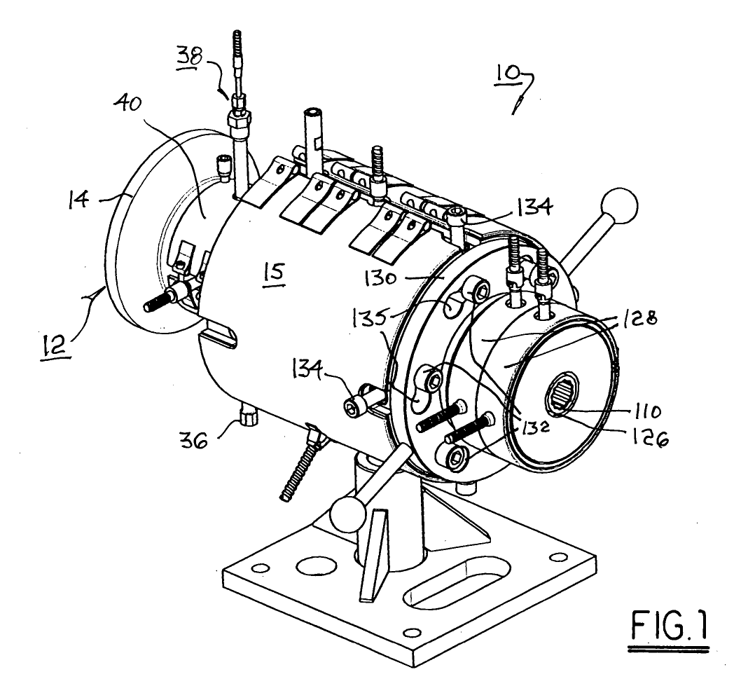

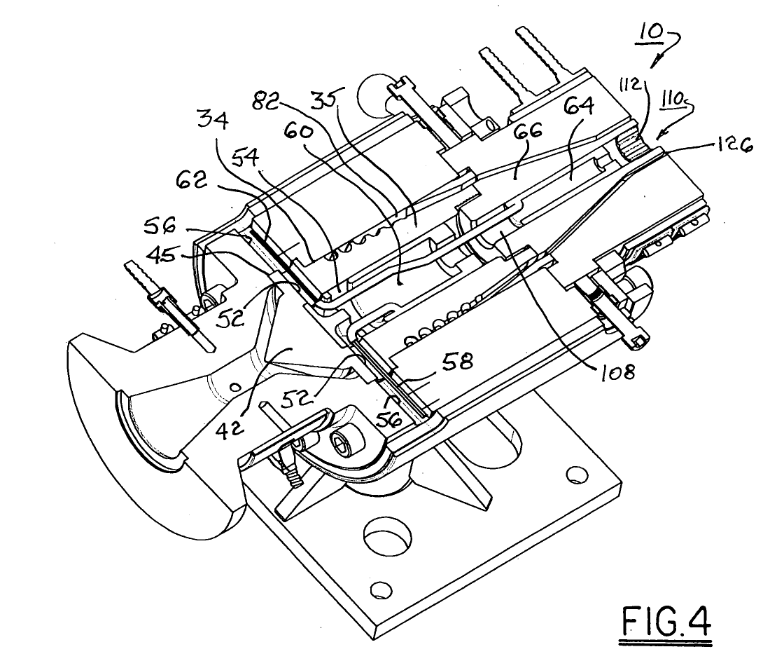

Referring to FIGS. 1 through 5, there is shown an improved inline polymer extrusion head 10 in accordance with the invention. A supply section 12 includes a flange adapter 14 for connecting to a source (not shown) of molten polymeric material, for example, a conventional progressive-screw extruder. Section 12 is adapted to sealingly mate with an extruder body 16 at an interface 18 and being secured thereto by bolts 17. Body 16 preferably is surrounded by a conventional band heater 15. A supply passage 22 in section 12, preferably conically tapered, connects to a supply passage 24. Passage 24 opens onto an expanding conical region 26 within section 12 which in turn opens onto a cylindrical bore 28 within and extending toward the end 30 of body 16. Preferably, a counterbore 32 is provided in end 30 for receiving an extrusion die, as described hereinbelow.

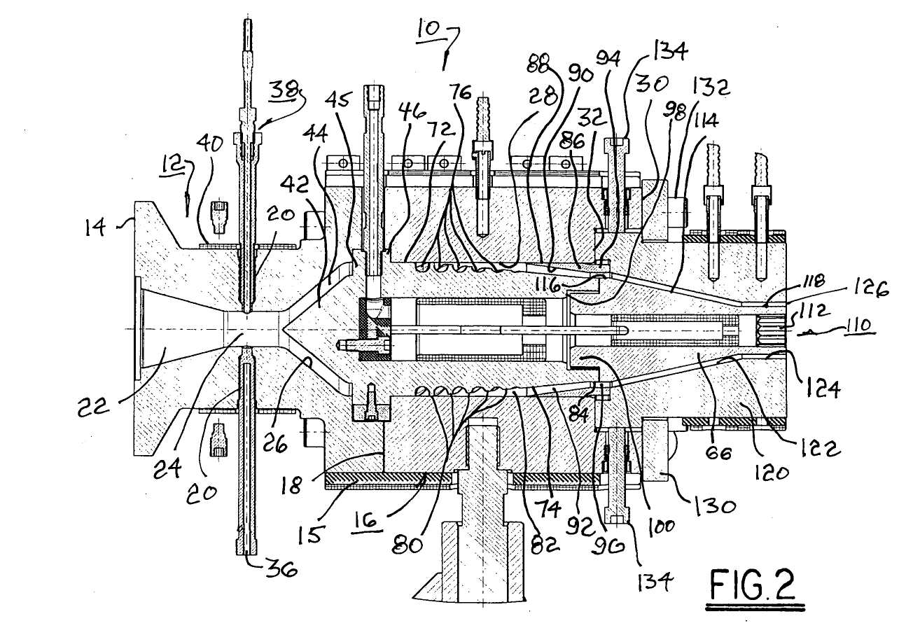

Radial access ports 20 may be provided in supply section 12, opening onto passage 24 as shown in FIG. 2, for receiving, for example, a pressure rupture safety disk 36 and a temperature sensor assembly 38. Preferably, a sleeve heater 40 surrounds the cylindrical portion of section 12.

A conical section 42 on helicoid manifold 35 is disposed coaxially within conical region 26, forming a conical flow chamber 44 wherein polymer flow is converted from axially columnar to axially annular. Adjacent to conical section 42 is a spider section 45 including a radial flange 46 captured between supply section 12 and body 16 to secure and accurately center manifold 35 coaxially within body 16. Inboard of flange 46, spider section 45 includes a plurality of annularly-arranged funnel-shaped channels 48, adjacent of which meet at their upstream ends in knife-edges 50. Because the channels taper in the direction of flow, polymer flow is accelerated. The smooth transition from conical section 42 into and through spider section 45 ensures that no stagnation regions are created.

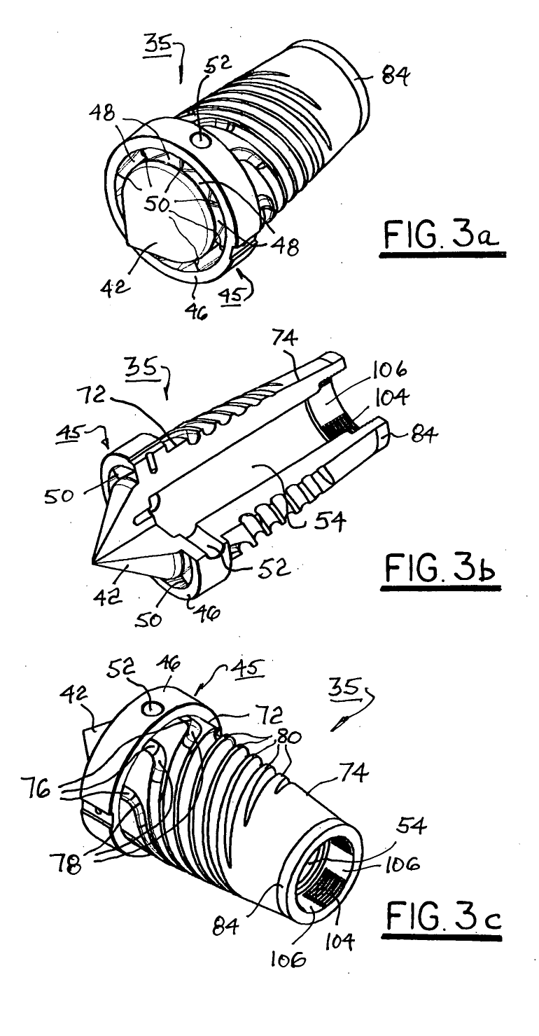

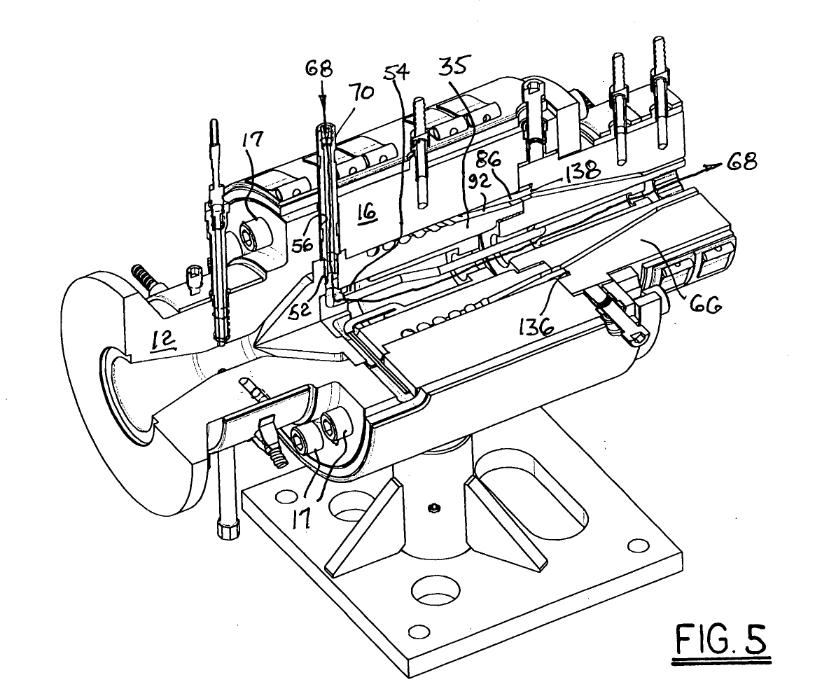

Preferably, helicoid manifold 35 (FIGS. 3a-3c) includes a plurality of radial passages 52 extending through spider section 45 into communication with an interior bore 54. Passages 52 also communicate with radial passages 56 formed in interface 18 between body 16 and supply section 12, such that the interior of the manifold is accessible from the exterior of the extrusion head assembly without passing through the polymer flowpath. Thus, wiring 58 may be inserted via passages 52,56 to energize an internal resistance heater 60 in the manifold, and wiring 62 may be inserted to energize an internal resistance heater 64 in extrusion tip 66. Also, compressed air 68 may be provided via an inlet fitting 70 (FIG. 5) and passages 52,56 to support pneumatically the interior of hollow forms such as pipe and tubing being extruded by head assembly 10.

Downstream of spider section 45 for a short distance, the outer surface mandrel section 34 of helicoid manifold 35 is cylindrical 72, then becomes conical 74. Cylindrical portion 72 is close-fitting to body bore 28. Within this cylindrical region, a plurality of axially-directed semi-cylindrical flow channels 76 are formed in cylindrical portion 72, each of which is smoothly connected to one of the funnel-shaped channels 48 in spider section 45 such that there are no stagnation points. In a currently preferred embodiment, there are eight such funnel-shaped channels 48 and eight such flow channels 76. Also within this cylindrical region, channels 76 are turned from axial to helical via smooth elbow bends 78. As the channel direction is changed from axial to helical, the surface of cylindrical portion 72 is changed to conical in portion 74 defining lands 80 between helical flow channels 76. Thus, a progressively deeper flow cavity 82 is formed between lands 80 and cylindrical bore 28. Further, the locus of bottoms of channels 76 define a virtual cylindrical surface such that channels 76 become progressively shallower as cavity 82 becomes deeper, and eventually the channels disappear altogether, leaving a smooth, unfigured, conical surface extending almost to the end of manifold 35. Preferably, a short portion 84 of the manifold surface is again cylindrical.

It is an important element of an extrusion head in accordance with the invention that helicoid manifold 35 is formed in a single piece, from a single blank of material. Thus, the internal interfaces known in the prior art from assembly of cone, spider, and mandrel are eliminated, resulting in a manifold having very uniform heat distribution, no cold spots, and no discontinuities to result in stagnation and slugging of polymer. Manifold 35 may be formed, preferably from a rod of suitable tool steel, by a combination of lathe turning, ball milling, and electric discharge machining. All flow surfaces of the manifold (and all other components exposed to the flowing polymer) are polished and may be plated via electroless nickel plating.

Within bore 28 and downstream of the disappearance of channels 76 is inserted a choke ring 86 having a cylindrical outer surface 88 and a conical inner surface 90. Preferably, the included cone angle of surface 90 is greater than that of conical portion 74 such that a conical annular flow space 92 formed therebetween is progressively shallower and is of a progressively smaller average radius. Preferably, a portion 94 of choke ring 86 is also formed as a cylinder, defining with portion 84 an annular flow space 96.

Manifold 35 is provided with a threaded counterbore 98 for coaxially receiving a threaded boss 100 extending from extrusion tip 66. Preferably, the female threads in counterbore 98 and the male threads 104 in tip 66 are interrupted to extend circumferentially in sections of threads and interruptions 106 of about 45° each. Thus, the tip may be secured in the manifold by inserting the boss into the counterbore and rotating it through 45° to fully engage the male and female threads, thereby permitting simple and rapid changing of extrusion tips as desired. Such attaching action further serves to securely anchor and center the extrusion tip to the manifold.

Extrusion tip 66 includes a central chamber 108 contiguous with interior bore 54 in manifold 35, chamber 108 opening at the outer end 110 of the tip. Preferably, tip 66 includes a tip heater 64 as recited above for bringing the tip outer surface to or near operating temperature at start-up, thereby preventing non-uniform flow or seizing of polymer within the extrusion head. Preferably, the opening of chamber 108 is fluted 112 to facilitate rotation and removal of the tip by a fluted tool (not shown).

The outer surface 114 of extrusion tip 66 is conical over most of its length, having a first short cylindrical portion 116 for mating with cylindrical portion 84 of manifold 35, and a second short cylindrical portion 118 adjacent tip end 110.

Surrounding tip 66 is extrusion die 120 having a conically tapered inner surface 122 preferably having substantially the same cone angle as tip surface 114 and also being cylindrical 124 around cylindrical portion 118, defining an extrusion annulus 126 therebetween. Die 120 is preferably provided with band heaters 128 for pre-heating of the die prior to start-up.

Die 120 is disposed in counterbore 32 in body 16 and is secured therein by a retaining ring 130 and bolts 132, ring 130 having slotted holes 135 for quick removal of the ring without full removal of the bolts, to change the die and tip for different sizes and shapes of extruded product. Die 120 is radially loose-fitting in counterbore 32 and is engaged by a plurality of positioning screws 134 threadedly engaged in radial bores in body 16. Thus, extrusion annulus 126 may be simply and very accurately adjusted by screws 134 after assembly of the extrusion head, and even during operation.

Referring to FIG. 5, extrusion die 120 is provided with a counterbored step 136 which serves as a seating surface for a sealing face 138 on choke ring 86. During extrusion operation, ring 86 is urged axially against step 136 by the pressure of molten polymer within conical annular flow space 92, thus effectively sealing against leakage at the entrance to the die, a common problem in prior art extrusion heads.

In operation, polymer is liquefied as by a conventional progressive-screw extruder (not shown) and is introduced into conical supply passage 22.

Polymer flows through passage 24 in columnar flow wherein the temperature of the melt is monitored by temperature sensor assembly 38.

Polymer engages conical section 42 and is spread in conical flow channel 44 into annular flow. The annular flow is divided by knife edges 50 between funnel-shaped channels 48 in spider section 45 into a plurality of axial flow streams which enter flow channels 76 without stagnation. Up to this point, flow velocity and pressure are continuously increased by the geometry of the passages in the head.

In cylindrical portion 72, the axial flow streams are turned by elbow bends 78 to become helical flow streams, thereby obviating longitudinal knit lines resulting from prior art extruders.

In flow cavity 82, the polymer progressively overflows lands 80 as the height of flow cavity 82 increases and the depth of channels 76 decreases, forming thereby a conically annular flow at the entrance to choke ring 86. At each point along channels 76, a portion of the polymer is overflowing axially into the next channel while the remainder is flowing helically along its own channel. The flow from the region of decreasing channel height thus comprises a complex multitude of very thin concentric “onion-skin” layers of polymer, the layers being indistinguishable after full passage through the extrusion head and the extruded element having a very high degree of polymeric structural uniformity. The flow velocity is continuously decreased in this section without any stagnation.

An important benefit of forming pipe in this way is that there are no longitudinal knit lines, and further, that the resulting pipe is stronger than prior art pipe. Thus, in many applications, pipe wall thicknesses may be reduced,. at an immediate savings in polymer consumed (although for drain/waste/vent pipe the wall thicknesses are fixed by industry schedules dictated by prior art pipe technology).

Polymer enters flow space 92 and is squeezed and accelerated again by passage through choke ring 86. The cone angles of portion 74 and surface 90 may be varied independently in manufacture to produce a desired pressure and flow profile through this section without stagnation. Polymer then enters the die proper wherein it is further accelerated and shaped to the desired cross-sectional profile by the mechanical relationship between die 120 and tip 66, and is extruded for cooling and/or further processing from extrusion annulus 126.

An extrusion head as just described is useful primarily for forming solid or tubular plastic elements. Of course, it will be readily seen that flexible core forms such as wires may also be coated by introducing such core forms into the extrusion head via passages 56,52 and providing suitable extrusion tips and dies 66,120.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. An extrusion head for continuous extrusion of molten polymer in a predetermined cross-sectional shape, the molten polymer being supplied from a source, comprising:
a) a body section having a bore therein;
b) a manifold element disposed at least partly within said body bore, said manifold including a conical section for converting polymer flow from columnar to annular, a spider section for dividing said annular flow into a plurality of individual flows, and a mandrel surface having a cylindrical portion and a conically tapered portion and having a plurality of channels formed in the surface for receiving said plurality of individual flows, said channels being axial within said cylindrical portion and helical within said conically tapered portion;
c) a choke ring disposed in said bore adjacent said conically tapered portion of said manifold element;
d) an extrusion tip connected to said manifold element; and
e) an extrusion die disposed around said extrusion tip and attached to said body section for cooperating with said tip to extrude said molten polymer in said predetermined cross-sectional shape.

2. An extrusion head in accordance with claim 1 further comprising a supply section connected to said body section for receiving said molten polymer from said source and conveying said polymer to said manifold element.

3. An extrusion head in accordance with claim 2 wherein said supply section includes a conical region for receiving said manifold element conical section to form a conical distribution channel.

4. An extrusion head in accordance with claim 2 wherein said spider section further comprises a mounting flange for capture between said supply section and said body section.

5. An extrusion head in accordance with claim 1 wherein said body section bore is cylindrical.

6. An extrusion head in accordance with claim 1 wherein said body section further comprises a counterbore for receiving said extrusion die.

7. An extrusion head in accordance with claim 1 wherein said spider section includes a plurality of annularly arranged funnel-shaped channels separated by a plurality of knife edges.

8. An extrusion head in accordance with claim 1 wherein said manifold element is formed from a single piece of stock.

9. An extrusion head in accordance with claim 1 wherein said plurality of channels becomes progressively shallower and farther from said body bore with length of said channels.

10. An extrusion head in accordance with claim 1 wherein said die includes an axial face for receiving an axial face of said choke ring for sealing said faces against radial polymer leakage.

11. An extrusion head in accordance with claim 1 wherein said manifold element includes a central cavity in communication with the outside of said extrusion head via at least one radial passage in said spider section and said body section.

12. An extrusion head in accordance with claim 11 comprising a manifold element heater disposed in said central cavity, heater wiring being disposed in said at least one radial passage.

13. An extrusion head in accordance with claim 11 further comprising a central cavity in said extrusion tip, said cavity being in communication with said manifold element cavity.

14. An extrusion head in accordance with claim 13 further comprising an extrusion tip heater disposed in said extrusion tip cavity, heater wiring being disposed in said at least one radial passage.

15. An extrusion head in accordance with claim 13 further comprising means for admitting pressurized air to said central cavities in said manifold element and said extrusion tip.

16. An extrusion head in accordance with claim 1 wherein said body section is provided with a counterbore and wherein said extrusion die is disposed and radially moveable within said counterbore, and wherein said body section further includes a plurality of positioning screws bearable against said extrusion die for radially positioning said die with respect to said extrusion tip.

17. An extrusion head in accordance with claim 1 wherein said manifold element is provided with a threaded counterbore and said extrusion tip is provided with a threaded boss for mating into said counterbore.

18. An extrusion head in accordance with claim 17 wherein said threads in said counterbore and said boss are interrupted such that said extrusion tip may be attached to or detached from said manifold element by rotating one of said counterbore and said boss through an angle of less than 360°.

19. A helicoid manifold for use in a polymer extrusion head, comprising:
a) a conical section for converting polymer flow from columnar to annular;
b) a spider section for dividing said annular flow into a plurality of individual flows, said spider section including a plurality of annularly arranged funnel-shaped channels separated by a plurality of knife edges; and
c) a mandrel surface having a cylindrical portion and a conically tapered portion and having a plurality of channels formed in the surface for receiving said plurality of individual flows, said channels being axial within said cylindrical portion and helical within said conically tapered portion.

20. A helicoid manifold in accordance with claim 19 wherein said manifold is formed from a single piece of material.

21. A helicoid manifold in accordance with claim 19 further comprising a central cavity in communication with the outside of said manifold via at least one radial passage in said spider section.

22. A helicoid manifold in accordance with claim 21 further comprising a manifold heater disposed in said central cavity.

23. A helicoid manifold in accordance with claim 19 wherein said manifold is adapted for a use selected from the group consisting of extrusion of a non-cored shape and coating of a core material.

24. A method for extruding molten polymer from an extrusion head, the molten polymer being supplied from a source, wherein the extrusion head includes
a supply section for receiving said molten polymer from the source,
a body section attached to the supply section and having a bore therein,
a manifold element disposed at least partly within body bore, the manifold including a conical section for converting polymer flow from columnar to annular, and a spider section having a plurality of annularly arrange funnel-shaped channels separated by knife edges for dividing the annular flow into a plurality of individual flows, and a mandrel surface having a cylindrical portion and a conically tapered portion and having a plurality of channels formed in the surface for receiving the plurality of individual flows, the channels being axial within the cylindrical portion and helical within the conically tapered portion,
a choke ring disposed in the bore adjacent the conically tapered portion of the manifold element,
an extrusion tip connected to the manifold element, and
an extrusion die disposed around the extrusion tip and attached to the body section for cooperating with the tip,
the method comprising the steps of:
a) entering molten polymer into said supply section in columnar flow;
b) passing said polymer over said conical section to convert said columnar flow to annular flow;
c) passing said polymer past said knife edges and through said funnel-shaped channels to convert said annular flow into a plurality of axially directed streams;
d) entering said plurality of axially directed streams into said plurality of channels in said manifold element;
e) turning the direction of said stream flow from axial to helical;
f) progressively overflowing polymer over helical lands between said plurality of channels in said manifold to form a plurality of polymer layers;
g) passing said polymer between said choke ring and said conically tapered portion of said manifold element to eliminate distinctions between said polymer layers;
h) passing said polymer between said extrusion tip and said die; and
i) extruding said polymer from said extrusion head.
